(19) United States
(12) Patent Application Publication
(10) Pub. No.: US 2006/0075394 A1
(43) Pub. Date: Apr. 6, 2006

(54) Dynamic loading and unloading for processing unit

(76) Inventor: Tatsuya Iwamoto, Austin, TX (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/957,158

(22) Filed: Oct. 1, 2004

(51) Int. Cl. G06F 9/44

(52) U.S. Cl. 717/162

(57) ABSTRACT

Methods and apparatus are provided for enhanced instruction handling in processing environments. A program reference may be associated with one or more program modules. The program modules may be loaded into local memory and information, such as code or data, may be obtained from the program modules based on the program reference. New program modules can be formed based on existing program modules. Generating direct references within a program module and avoiding indirect references between program modules can optimize the new program modules. A program module may be preloaded in the local memory based upon an insertion point. The insertion point can be determined statistically. The invention is particularly beneficial for multiprocessor systems having limited amounts of memory.

### BACKGROUND OF THE INVENTION

The present invention relates generally to computer program execution. More particularly, the present invention relates to improving program execution by manipulating program modules and by loading program modules in local storage of a processor based upon object modules.

Computing systems are becoming increasingly more complex, achieving higher processing speeds while at the same time shrinking component size and reducing manufacturing costs. Such advances are critical to the success of many applications, such as real-time, multimedia gaming and other computation-intensive applications. Often, computing systems incorporate multiple processors that operate in parallel (or in concert) to increase processing efficiency.

At a basic level, the processor or processors manipulate code and/or data (collectively “information”). Information is typically stored in a main memory. The main memory can be, for example, a dynamic random access memory (“DRAM”) chip that is physically separate from the chip containing the processor(s). When the main memory is physically or logically separate from the processor, there can be significant delays (“high latency”) that may be, for example, tens or hundreds of milliseconds in additional time required to access the information contained in the main memory. High latency adversely affects processing because the processor may have to idle or pause operation until the necessary information has been delivered from the main memory.

In order to address high latency problems, many computer systems implement cache memory. Cache memory is a temporary storage located between the processor and the main memory. Cache memory generally has small access latency (“low latency”) compared to the main memory, but has a much smaller storage size. When used, cache memory helps improve processor performance by temporarily storing data for repeated access. The effectiveness of cache memory relies on the locality of access. For example, using a “9 to 1” rule, where 90% of the time is spent accessing 10% of the data, retrieving even a small amount of data from main memory or external storage is not very effective since too much time is spent accessing that little amount of data. Thus, often-used data should be stored in the cache.

A conventional hardware cache system contains “cache lines” which are basic units of storage management. Cache lines are selected to be the optimal size of data transfer between the cache memory and the main memory. As is known in the art, cache systems operate with certain rules mapping the cache lines to the main memory. For instance, Cache “tags” are utilized showing which part(s) of the main memory is stored on the cache lines, and the status of that portion of main memory.

Another limitation besides memory access that can adversely affect program execution is memory size. The main memory may simply be too small to perform needed operations. In this case, “virtual memory” can be used to provide larger system address space than physically exists in main memory by utilizing external storage. However, external storage typically has much higher latency than main memory.

In order to implement virtual memory, it is common to utilize the memory management unit (“MMU”) of the processor, which can be a part of the CPU or a separate element. The MMU manages mapping of virtual addresses (the addresses used by the program software) to physical addresses in memory. The MMU can detect when an access is made to a virtual address that is not tied to a physical address. When this occurs, the virtual memory manager software is called. If the virtual address has been saved in external storage, it will be loaded into main memory and a mapping will be made for the virtual address.

In advanced processor architectures, particularly multiprocessor architectures, the individual processing units may have local memories, which can supplement the storage in main memory. The local memories are often high speed, but with limited storage capacity. There is no virtualization between the address used by software and the physical address of the local memory. This limits the amount of memory that a processing unit can use. While the processing unit may access main memory via a direct memory access (“DMA”) controller (“DMAC”) or other hardware, there is no hardware mechanism which links the local memory address space with the system address space.

Unfortunately, the high latency main memory still contributes to reduced processing efficiency, and for multiprocessor systems can create a serious bottleneck for performance. Therefore, a need exists for enhanced information handling to overcome such problems. The present invention addresses these and other problems, and is particularly suited to multiprocessor architectures with strict memory constraints.

### SUMMARY OF THE INVENTION

In accordance with an embodiment of the present invention, a method of managing operations in a processing apparatus which has a local memory is provided. The method comprises determining if a program module is loaded in the local memory, the programming module being associated with a programming reference; loading the program module into the local memory if the program module is not loaded in the local memory; and obtaining information from the program module based upon the programming reference.

In one alternative, the information obtained from the program module comprises at least one of data and code. In another alternative, the program module comprises an object module loaded in the local memory from a main memory. In yet another alternative, the programming reference comprises a direct reference within the program module. In a further alternative, the programming reference comprises an indirect reference to a second program module.

In another alternative, the program module is a first program module and the method further comprises storing the first program module and a second program module in a main memory, wherein the loading step includes loading the first program module into the local memory from the main memory. In this case, the programming reference may comprise a direct reference within the first program module. Alternatively, the programming reference may comprise an indirect reference to the second program module. In this example, when the information is obtained from the second program module, the method preferably further comprises determining if the second program module is loaded in the local memory; loading the second program module into the local memory if the second program module is not loaded in the local memory; and providing the information to the first program module.

In accordance with another embodiment of the present invention, a method of managing operations in a processing apparatus which has a local memory is provided. The method comprises obtaining a first program module from a main memory; obtaining a second program module from the main memory; determining if a programming reference used by the first program module comprises an indirect reference to the second program module; and forming a new program module if the programming reference comprises the indirect reference, the new program module comprising at least a portion of the first program module so that the programming reference becomes a direct reference between portions of the new program module.

In one alternative, the method further comprises loading the new program module into the local memory. In another alternative the first and second program modules are loaded in the local memory before forming the new program module. In a further alternative, the first program module comprises a first code function, the second program module comprises a second code function, and the new program module is formed to include at least one of the first and second code functions. In this case, the first program module preferably further comprises a data group, and the new program module is formed to further include the data group.

In another alternative, the programming reference is an indirect reference to the second program module and the method further comprises determining a new programming reference for use by the new program module based on the programming reference used by the first program module; wherein the new program module is formed to comprise at least the portion of the first program module and at least a portion of the second program module so that the new programming reference is a direct reference within the new program module.

In accordance with yet another embodiment of the present invention, a method of processing operations in a processing apparatus which has a local memory is provided. The method comprises executing a first program module loaded in the local memory; determining an insertion point for a second program module; loading the second program module in the local memory during execution of the first program module; determining an anticipated execution time to begin execution of the second program module; determining whether loading of the second program module is complete; and executing the second program module after execution of the first program module is terminated.

In one alternative, the method further comprises delaying execution of the second program module if loading is not complete. In this case, delaying execution desirably comprises performing one or more NOPs until loading is complete. In another alternative, the insertion point is determined statistically. In a further alternative, the validity of the insertion point is determined based on runtime conditions.

In accordance with another embodiment of the present invention, a processing system is provided. The processing system comprises a local memory capable of storing a program module; and a processor connected to the local memory. The processor includes logic to perform a management function comprising associating a programming reference with the program module, determining if the program module is currently loaded in the local memory, loading the program module into the local memory if the program module is not currently loaded in the local memory, and obtaining information from the program module based upon the programming reference. The local memory is preferably integrated with the processor.

In accordance with yet another embodiment of the present invention, a processing system is provided. The processing system comprises a local memory capable of storing program modules; and a processor connected to the local memory. The processor includes logic to perform a management function comprising storing first and second ones of the program modules in a main memory, loading a selected one the first and second program modules into the local memory from the main memory, associating a programming reference with the selected program module, and obtaining information based upon the programming reference. Preferably the main memory comprises an on-chip memory. More preferably, the main memory is integrated with the processor.

In accordance with a further embodiment of the present invention, a processing system is provided. The processing system comprises a local memory capable of storing program modules; and a processor connected to the local memory. The processor includes logic to perform a management function comprising obtaining a first program module from a main memory, obtaining a second program module from the main memory, determining a first programming reference for use by the first program module, forming a new program module comprising at least a portion of the first program module so that the first programming reference becomes a direct reference within the new program module, and loading the new program module into the local memory.

In accordance with another embodiment of the present invention, a processing system is provided. The processing system comprises a local memory capable of storing the program modules; and a processor connected to the local memory. The processor includes logic to perform a management function comprising determining an insertion point for a first program module, loading the first program module in the local memory during execution of a second program module by the processor, and executing the first program module after execution of the second program module is terminated and loading is complete.

In accordance with a further embodiment of the present invention, a storage medium storing a program for use by a processor is provided. The program cause the processor to: identify a program module associated with a programming reference; determine if the program module is currently loaded in a local memory associated with the processor; load the program module into the local memory if the program module is not currently loaded in the local memory; and obtain information from the program module based upon the programming reference.

In accordance with another embodiment of the present invention, a storage medium storing a program for use by a processor is provided. The program causes the processor to: store first and second program modules in a main memory; load the first program module into a local memory associated with the processor from the main memory, the first program module being associated with a programming reference; and obtain information based upon the programming reference.

In accordance with yet another embodiment of the present invention, a storage medium storing a program for use by a processor is provided. The program causes the processor to obtain a first program module from a main memory; obtain a second program module from the main memory; determine if a programming reference used by the first program module comprises an indirect reference to the second program module; and form a new program module if the programming reference comprises the indirect reference, the new program module comprising at least a portion of the first program module so that the programming reference becomes a direct reference between portions of the new program module.

In accordance with a further embodiment of the present invention, a storage medium storing a program for use by a processor is provided. The program causes the processor to execute a first program module loaded in a local memory associated with the processor; determine an insertion point for a second program module; load the second program module in the local memory during execution of the first program module; determine an anticipated execution time to begin execution of the second program module; determine whether loading of the second program module is complete; and execute the second program module after execution of the first program module is terminated.

In accordance with another embodiment of the present invention, a processing system is provided. The processing system comprises a processing element including a bus, a processing unit and at least one sub-processing unit connected to the processing unit by the bus. At least one of the processing unit and the at least one sub-processing units are operable to determine whether a programming reference belongs to a first program module, to load the first program module into a local memory, and to obtain information from the first program module based upon the programming reference.

In accordance with yet another embodiment of the present invention, a computer processing system is provided. The computer processing system comprises a user input device; a display interface for attachment of a display device; a local memory capable of storing program modules; and a processor connected to the local memory. The processor comprises one or more processing elements. At least one of the processor elements includes logic to perform a management function comprising determining whether a programming reference belongs to a first program module, loading the first program module into the local memory, and obtaining information from the first program module based upon the programming reference.

In accordance with yet another embodiment of the present invention, a computer network is provided. The computer network comprises a plurality of computer processing systems connected to one another via a communications network. Each of the computer processing systems comprises a user input device; a display interface for attachment of a display device; a local memory capable of storing program modules; and a processor connected to the local memory. The processor comprises one or more processing elements. At least one of the processor elements includes logic to perform a management function comprising determining whether a programming reference belongs to a first program module, loading the first program module into the local memory, and obtaining information from the first program module based upon the programming reference. Preferably, at least one of the computer processing systems comprises a gaming unit capable of processing multimedia gaming applications.

### BRIEF DESCRIPTION OF THE DRAWINGS

FIG. 1 is a diagram illustrating an exemplary structure of a processing element that can be used in accordance with aspects of the present invention.

FIG. 2 is a diagram illustrating an exemplary structure of a multiprocessing system of processing elements usable with aspects of the present invention.

FIG. 3 is a diagram illustrating an exemplary structure of a sub-processing unit.

FIGS. 4A-B illustrate a storage management diagram between main memory and a local store and an associated logic flow diagram in accordance with a preferred aspect of the present invention.

FIGS. 5A-B illustrate diagrams of program module regrouping in accordance with preferred aspects of the present invention.

FIGS. 6A-B illustrate diagrams of call tree regrouping in accordance with preferred aspects of the present invention.

FIGS. 7A-B illustrate program module preloading logic and diagrams in accordance with preferred aspects of the present invention.

FIG. 8 illustrates a computing network in accordance with aspects of the present invention.

### DETAILED DESCRIPTION

In describing the preferred embodiments of the invention illustrated in the appended drawings, specific terminology will be used for the sake of clarity. However, the invention is not intended to be limited to the specific terms used, and it is to be understood that each specific term includes all technical equivalents that operate in a similar manner to accomplish a similar purpose.

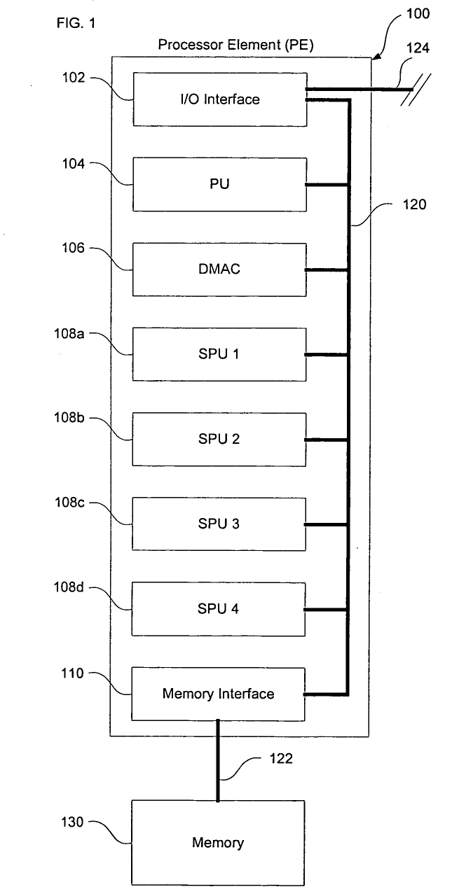

Reference is now made to FIG. 1, which is a block diagram of a basic processing module or processor element (“PE”) 100 that can be employed in accordance with aspects of the present invention. As shown in this figure, the PE 100 preferably comprises an I/O interface 102, a processing unit (“PU”) 104, a direct memory access controller (“DMAC”) 106, and a plurality of sub-processing units (“SPUs”) 108, namely SPUs 108a-108d. While four SPUs 108a-d are shown, the PE 100 may include any number of such devices. A local (or internal) PE bus 120 transmits data and applications among PU 104, the SPUs 108, I/O interface 102, DMAC 106 and a memory interface 110. Local PE bus 120 can have, for example, a conventional architecture or can be implemented as a packet switch network. Implementation as a packet switch network, while requiring more hardware, increases available bandwidth. The I/O interface 102 may connect to one or more external I/O devices (not shown), such as frame buffers, disk drives, etc. via an I/O bus 124.

PE 100 can be constructed using various methods for implementing digital logic. PE 100 preferably is constructed, however, as a single integrated circuit employing CMOS on a silicon substrate. PE 100 is closely associated with a memory 130 through a high bandwidth memory connection 122. The memory 130 desirably functions as the main memory for PE 100. In certain implementations, the memory 130 may be embedded in or otherwise integrated as part of the processor chip incorporating the PE 100, as opposed to being a separate, external “off chip” memory. For instance, the memory 130 can be in a separate location on the chip or can be integrated with one or more of the processors that comprise the PE 100. Although the memory 130 is preferably a DRAM, the memory 130 could be implemented using other means, such as a static random access memory (“SRAM”), a magnetic random access memory (“MRAM”), an optical memory, a holographic memory, etc. DMAC 106 and memory interface 110 facilitate the transfer of data between the memory 130 and the SPUs 108 and PU 104 of the PE 100.

PU 104 can be, for instance, a standard processor capable of stand-alone processing of data and applications. In operation, the PU 104 schedules and orchestrates the processing of data and applications by the SPUs 108. In an alternative configuration, the PE 100 may include multiple PUs 104. Each of the PUs 104 may control one, all, or some designated group of the SPUs 108. The SPUs 108 are preferably single instruction, multiple data (“SIMD”) processors. Under the control of PU 104, the SPUs 108 may perform the processing of the data and applications in a parallel and independent manner. DMAC 106 controls accesses by PU 104 and the SPUs 108 to the data and applications stored in the shared memory 130. Preferably, a number of PEs, such as PE 100, may be joined or packed together, or otherwise logically associated with one another, to provide enhanced processing power.

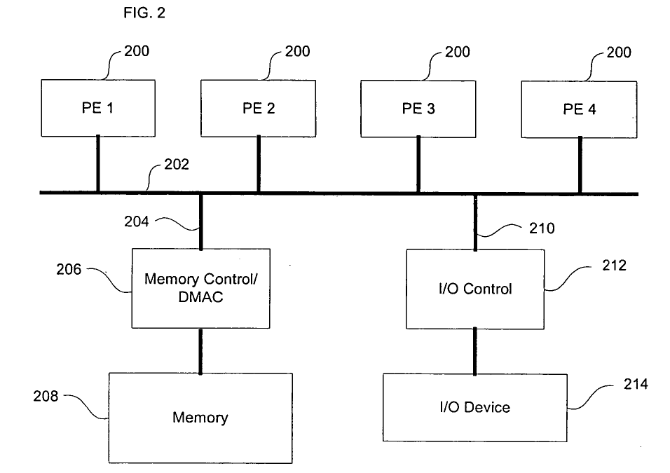

FIG. 2 illustrates a processing architecture comprised of multiple PEs 200 (PE 1, PE 2, PE 3, and PE 4) that can be operated in accordance with aspects of the present invention as described below. Preferably, the PEs 200 are on a single chip. The PEs 200 may or may not include the subsystems such as the PU and/or SPUs discussed above with regard to the PE 100 of FIG. 1. The PEs 200 may be of the same or different types, depending upon the types of processing required. For example, one or more of the PEs 200 may be a generic microprocessor, a digital signal processor, a graphics processor, microcontroller, etc. One of the PEs 200, such as PE 1, may control or direct some or all of the processing by PEs 2, 3 and 4.

The PEs 200 are preferably tied to a shared bus 202. A memory controller or DMAC 206 may be connected to the shared bus 202 through a memory bus 204. The DMAC 206 connects to a memory 208, which may be of one of the types discussed above with regard to memory 130. In certain implementations, the memory 208 may be embedded in or otherwise integrated as part of the processor chip incorporating one or more of the PEs 200, as opposed to being a separate, external off chip memory. For instance, the memory 208 can be in a separate location on the chip or can be integrated with one or more of the PEs 200. An I/O controller 212 may also be connected to the shared bus 202 through an I/O bus 210. The I/O controller 212 may connect to one or more I/O devices 214, such as frame buffers, disk drives, etc.

It should be understood that the above processing modules and architectures are merely exemplary, and the various aspects of the present invention may be employed with other structures, including, but not limited to multiprocessor systems of the types disclosed in U.S. Pat. No. 6,526,491, entitled “Memory Protection System and Method for Computer Architecture for Broadband Networks,” issued on Feb. 25, 2003, and U.S. application Ser. No. 09/816,004, entitled “Computer Architecture and Software Cells for Broadband Networks,” filed on Mar. 22, 2001, which are hereby expressly incorporated by reference herein.

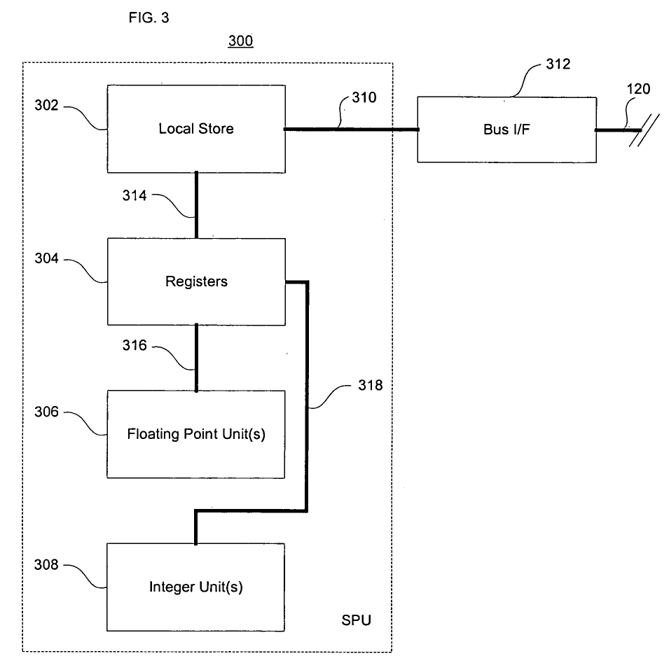

FIG. 3 illustrates an SPU 300 that can be employed in accordance with aspects of the present invention. One or more SPUs 300 may be integrated in the PE 100. In a case where the PE includes multiple PUs 104, each of the PUs 104 may control one, all, or some designated group of the SPUs 300.

SPU 300 preferably includes or is otherwise logically associated with local store (“LS”) 302, registers 304, one or more floating point units (“FPUs”) 306 and one or more integer units (“IUs”) 308. The components of SPU 300 are, in turn, comprised of subcomponents, as will be described below. Depending upon the processing power required, a greater or lesser number of FPUs 306 and IUs 308 may be employed. In a preferred embodiment, LS 302 contains at least 128 kilobytes of storage, and the capacity of registers 304 is 128×128 bits. FPUs 306 preferably operate at a speed of at least 32 billion floating point operations per second (32 GFLOPS), and IUs 308 preferably operate at a speed of at least 32 billion operations per second (32 GOPS).

LS 302 is preferably not a cache memory. Cache coherency support for the SPU 300 is unnecessary. Instead, the LS 302 is preferably constructed as an SRAM. A PU 104 may require cache coherency support for direct memory access initiated by the PU 104. Cache coherency support is not required, however, for direct memory access initiated by the SPU 300 or for accesses to and from external devices, for example, I/O device 214. LS 302 may be implemented as, for example, a physical memory associated with a particular SPU 300, a virtual memory region associated with the SPU 300, a combination of physical memory and virtual memory, or an equivalent hardware, software and/or firmware structure. If external to the SPU 300, the LS 302 may be coupled to the SPU 300 such as via a SPU-specific local bus or via a system bus such as the local PE bus 120.

SPU 300 further includes bus 310 for transmitting applications and data to and from the SPU 300 through a bus interface (Bus I/F) 312. In a preferred embodiment, bus 310 is 1,024 bits wide. SPU 300 further includes internal busses 314, 316 and 318. In a preferred embodiment, bus 314 has a width of 256 bits and provides communication between local store 302 and registers 304. Busses 316 and 318 provide communications between, respectively, registers 304 and FPUs 306, and registers 304 and IUs 308. In a preferred embodiment, the width of busses 316 and 318 from registers 304 to the FPUs 306 or IUs 308 is 384 bits, and the width of the busses 316 and 318 from the FPU 306 or IUs 308 to the registers 304 is 128 bits. The larger width of the busses from the registers 304 to the FPUs 306 and the IUs 308 accommodates the larger data flow from the registers 304 during processing. In one example, a maximum of three words are needed for each calculation. The result of each calculation, however, is normally only one word.

With the present invention, it is possible to overcome the lack of virtualization and other bottleneck issues between the local memory address space and the system address space. Because data loading and unloading in the LS 302 is desirably performed through software, it is possible to utilize the fact that the software can determine whether data and/or code should be loaded at a certain time or not. This is accomplished through the use of program modules. As used herein, the term “program module” includes, but is not limited to, any logical set of program resources allocated in a memory. By way of example only, a program module may comprise data and/or code, which can be grouped by any logical means, such as a compiler. A program or other computing operations may be implemented using one or more program modules.

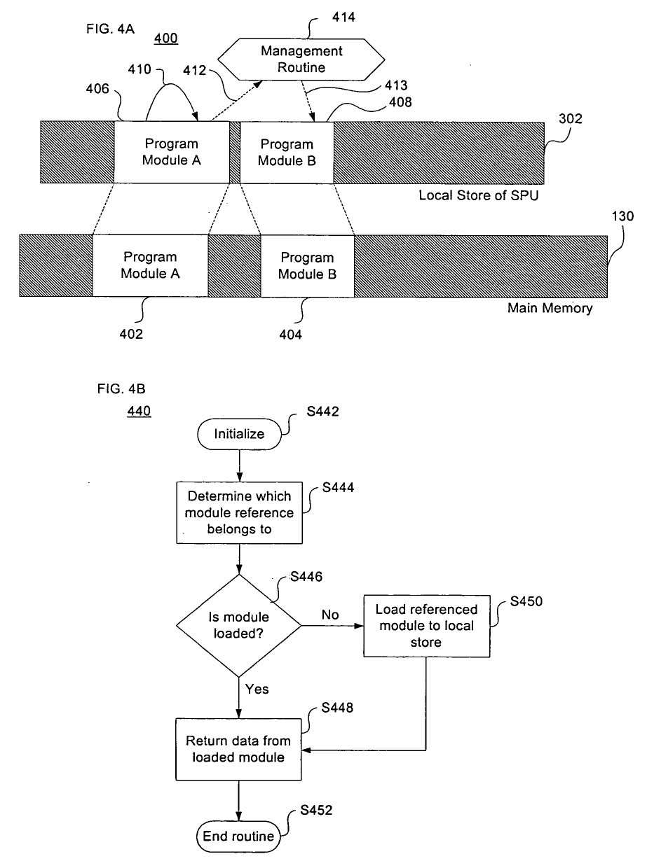

FIG. 4A is an illustration 400 of storage management in accordance with one aspect of the present based on the use of program modules. The main memory, for example, memory 130, may contain one or more program modules. In FIG. 4A, a first program module 402 (Program Module A), and a second program module 404 (Program Module B), are shown in main memory 130. In a preferred example, the program module may be a compile-time object module, known as a “*.o” file. Object modules provide very clear logical partitioning between program parts. Because an object module is created during compilation, it provides accurate address referencing, whether made within the module (“direct referencing”) or outside of it (“external referencing” or “indirect referencing”). Indirect referencing is preferably implemented by calling a management routine, as will be discussed below.

Preferably, programs are loaded into the LS 302 per program module. More preferably, programs are loaded into the LS 302 per object module. As seen in FIG. 4A, Program Module A can be loaded into the LS 302 as a first program module 406, and Program Module B can be loaded as a second program module 408. When direct referencing, as indicated by arrow 410, is performed to access data or code within the module, as seen within program module 406, all of the references (e.g., pointers to code and/or data) can be accessed without overhead. When indirect referencing is made outside the module, as seen by dashed arrows 412 and 413 from program module 406 to program module 408, a management routine 414 is preferably called. The management routine 414, which is preferably run by the processor's logic, can load the program module if needed, or can access the program module if it is already loaded. For example, assume indirect reference 412 is made in the first program module 406 (Program Module A). Further assume that the indirect reference 412 is to Program Module B, which is not found in the local store 302. Then, the management routine 414 can load program module B, which resides in main memory 130 as the program module 404, into the local store 302 as the program module 408.

FIG. 4B is a logic flow diagram 440 representing storage management according to a preferred aspect of the present invention. Storage management is initialized at step S442. Then at step S444, a check is performed to determine which program module a reference belongs to. The management routine 414 (FIG. 4A) may perform the check, or the results of the check may be provided to the management routine 414 by, for example, another process, application or device. Once the reference is determined, a check is performed at step S446 to determine whether that program module has been loaded into the LS 302. If the program module is loaded in the LS 302, the value (data) referenced from the program module is returned to the requesting entity, such as the program module 406 of FIG. 4A, at step S448. If the program module is not loaded in the LS 302, then the referenced module is loaded into the LS 302 at step S450. Once this occurs, the process proceeds to step S448 where the data is returned to the requesting entity. The storage management routine terminates at step S452. The management routine 414 preferably performs or oversees the storage management of diagram 400.

If program modules are implemented using object modules formed during compilation, how the object modules are structured can impact the effectiveness of the storage management process. For example, if the data for a code function is not properly associated with that code function, this could create a processing bottleneck. Thus, one should be cautious when separating programs and/or data into multiple source files.

This problem can be avoided by analyzing the program, including the code and data (if any). In one alternative, the code and/or data are preferably divided into separate modules. In another alternative, the code and/or data are divided into functions or groups of data, depending upon their usage. A compiler or other processing tool can analyze the references made between functions and groups of data. Then, existing program modules can be repartitioned by grouping the data and/or code into new program modules based on the analysis to optimize the program module grouping. This, in turn, will minimize the overhead created by out-of-module access. The process of determining how to split a module preferably begins by separating the module's code by functions. By way of example only, a tree structure can be extracted from the “call out” relationships of the functions. A function with no external call out, or a function which is not being referenced externally, can be identified as a “local” function. Functions having external references can be grouped by reference target modules, and should be identified as having an external reference. Similar groupings can be implemented for functions that are referenced externally, and such functions should be identified as being subject to an external reference. The data portion(s) of a module preferably undergo an equivalent analysis. The module groupings are preferably compared/matched to select a “best fit” combination. The best fit could be selected, for instance, based on the size of the LS 302, preferred transfer size, and/or alignment. Preferably, the more likely a reference is to be used, the higher it is weighted in the best fit analysis. Tools can also be used to automate the optimized grouping. For instance, the compiler and/or the linker may perform one or more compile/link iterations in order to generate a best fit executable file. References can also be statistically analyzed by runtime profiling.

In a preferred embodiment, the input to the regrouping process includes multiple object files that will be linked together to form a program. In such an embodiment, the desired output includes multiple load modules grouped to minimize the delay caused in waiting for a load completion.

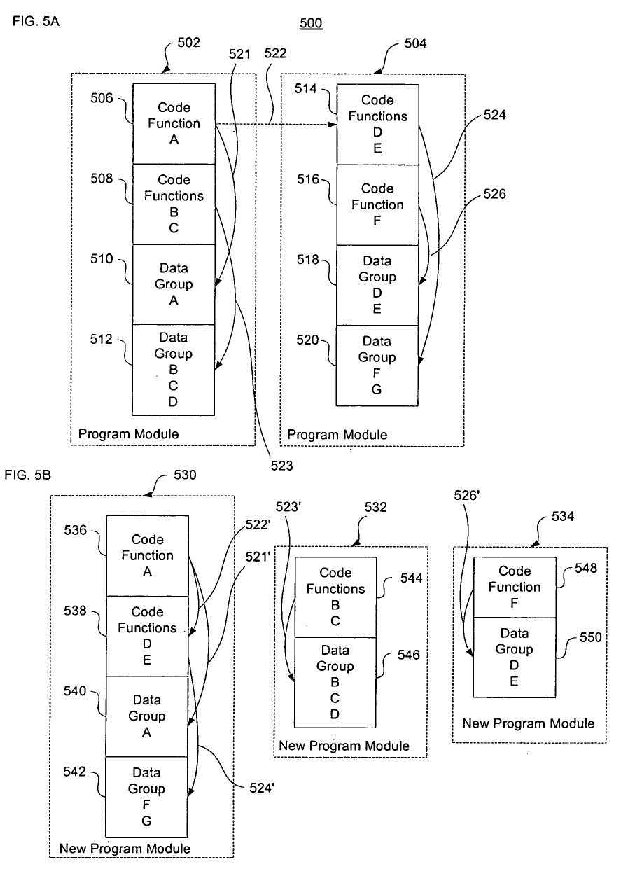

FIG. 5A illustrates a program module group 500 having a first program module 502 and a second program module 504, which are preferably loaded in the LS 302 of an SPU. Because it is possible to share the same code module between different threads in a multithreaded process, it is possible to load the first program module 502 into a first local store and to load the second program module into a second local store. Alternatively, the entire program module group 500 could be loaded into a pair of local stores. However, data modules require separate instances. Also, it is possible to extend the method of dynamic loading and unloading so that a shared code module can be used while a management routine manages separate data modules associated with the shared code module. As shown in FIG. 5A, the first program module 502 includes code functions 506 and 508 and data groups 510 and 512. The code function 506 includes the code for operation A. The code function 508 includes the code for operations B and C. The data group 510 includes data set A. The data group 512 includes data sets B, C and D. Similarly, the second program module 504 includes code functions 514, 516 and data groups 518, 520. The code function 514 includes the code for operations D and E. The code function 516 includes the code for operation F. The data group 518 includes data sets D and E. The data group 520 includes data sets F and G.

In the example of FIG. 5A, the code function 506 may directly reference the data group 510 (arrow 521) and may indirectly reference the code function 514. The code function 508 may directly reference the data group 512 (arrow 523). The code function 514 may directly reference the data group 520 (arrow 524). Finally, the code function 516 may directly reference the data group 518 (arrow 526). The indirect reference between code functions 506 and 514 (dashed arrow 522) creates unwanted overhead. Therefore, it is preferable to regroup the code functions and the data groups.

FIG. 5B illustrates an exemplary regrouping of the program module group 500 of FIG. 5A. In FIG. 5B, new program modules 530, 532 and 534 are generated. The program module 530 includes code functions 536, 538 and data groups 540, 542. The code function 536 includes the code for operation A. The code function 538 includes the code for operations D and E. The data group 540 includes data set A. The data group 542 includes data sets F and G. The program module 532 includes code function 544 and data group 546. The code function 544 includes the code for operations B and C. The data group 546 includes data sets B, C and D. The program module 534 includes code function 548 and data group 550. The code function 548 includes the code for operation F. The data group 550 includes data sets D and E.

In the regrouping of FIG. 5B, the code function 536 may directly reference the data group 540 (arrow 521′) and may directly reference the code function 538 (arrow 522′). The code function 544 may directly reference the data group 546 (arrow 523′). The code function 538 may directly reference the data group 542 (arrow 524′). Finally, the code function 548 may directly reference the data group 550 (arrow 526′). Grouping is optimized in FIG. 5B because direct referencing is maximized while indirect referencing is eliminated.

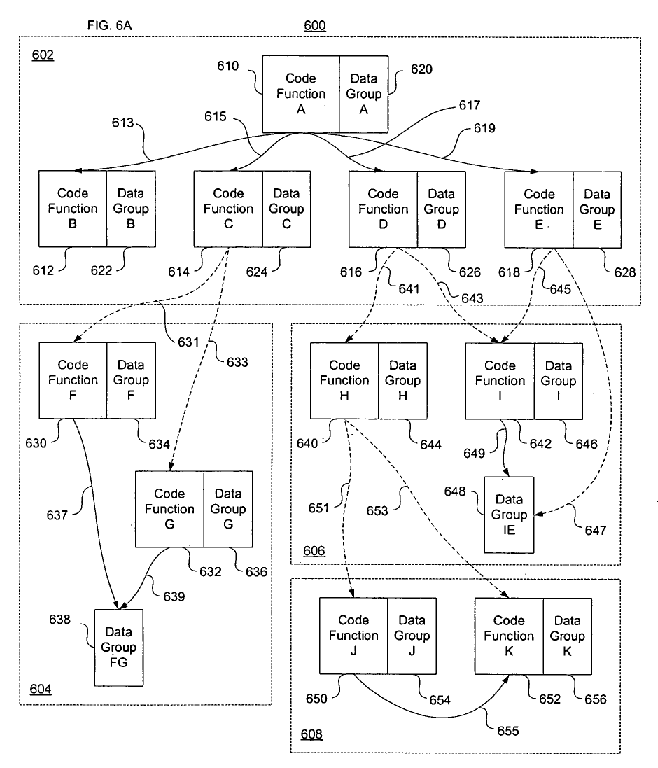

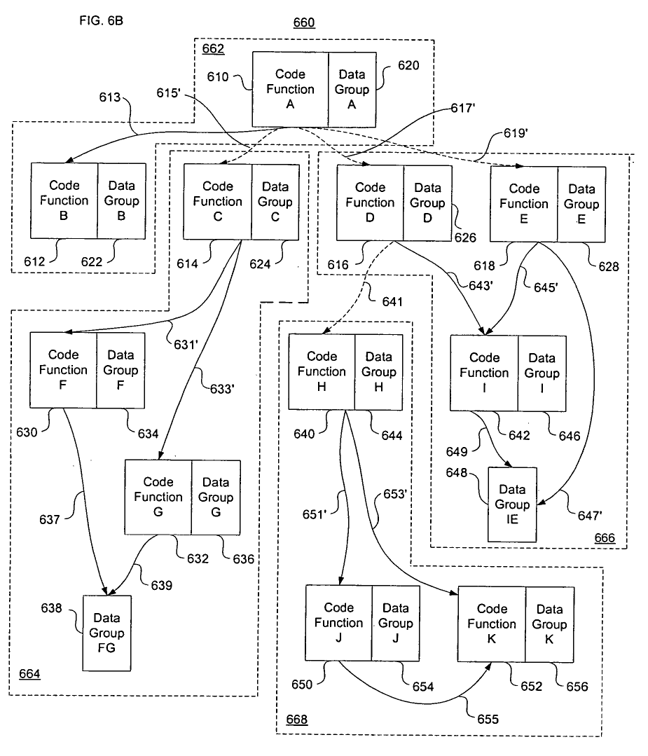

In a more complicated example, FIG. 6A illustrates a function call tree 600 having a first module 602, a second module 604, a third module 606 and a fourth module 608, which may be loaded in the LS 302 of an SPU. As shown in FIG. 6A, the first module 602 includes code functions 610, 612, 614, 616 and 618. The code function 610 includes the code for operation A. The code function 612 includes the code for operation B. The code function 614 includes the code for operation C. The code function 616 includes the code for operation D. The code function 618 includes the code for operation E. The first module 602 also includes data groups 620, 622, 624, 626 and 628, which are associated with the code functions 610, 612, 614, 616 and 618, respectively. The data group 620 includes data set (or group) A. The data group 622 includes data set B. The data group 624 includes data set C. The data group 626 includes data set D. The data group 628 includes data set E.

The second module 604 includes code functions 630 and 632. The code function 630 includes the code for operation F. The code function 632 includes the code for operation G. The second module 604 includes data groups 634 and 636, which are associated with the code functions 630 and 632, respectively. Data group 638 is also included in the second module 604. The data group 634 includes data set (or group) F. The data group 636 includes data set G. The data group 638 includes data set FG.

The third module 606 includes code functions 640 and 642. The code function 640 includes the code for operation H. The code function 642 includes the code for operation I. The third module 606 includes data groups 644 and 646, which are associated with the code functions 640 and 642, respectively. Data group 648 is also included in the third module 606. The data group 644 includes data set (or group) H. The data group 646 includes data set I. The data group 648 includes data set IE.

The fourth module 608 includes code functions 650 and 652. The code function 650 includes the code for operation J. The code function 652 includes the code for operation K. The fourth module 608 includes data groups 654 and 656, which are associated with the code functions 640 and 642, respectively. The data group 654 includes data set (or group) J. The data group 656 includes data set K.

In the example of FIG. 6A, with respect to the first code module 602, the code function 610 directly references code function 612 (arrow 613), code function 614 (arrow 615), code function 616 (arrow 617), and code function 618 (arrow 619). The code function 614 indirectly references code function 630 (dashed arrow 631) and code function 632 (dashed arrow 633). The code function 616 indirectly references code function 640 (dashed arrow 641) and code function 642 (dashed arrow 643). The code function 618 indirectly references code function 642 (dashed arrow 645) and data group 648 (dashed arrow 647).

With respect to the second code module 604, the code function 630 directly references data group 638 (arrow 637). The code function 632 also directly references data group 638 (arrow 639). With respect to the third code module 606, the code function 640 indirectly references code function 650 (dashed arrow 651). The code function 640 also indirectly references code function 652 (dashed arrow 653). The code function 642 directly references data group 648 (arrow 649). With respect to the fourth code module 608, the code function 650 directly references code function 652 (arrow 655).

There are eight local calls (direct references) and eight external calls (indirect references) in the function call tree 600. The eight external calls may create a significant amount of unwanted overhead. Therefore, it is preferable to regroup the components of the call tree 600 to minimize the indirect references.

FIG. 6B illustrates a regrouped function call tree 660 having a first module 662, a second module 664, a third module 666 and a fourth module 668, which may be loaded in the LS 302 of an SPU. As shown in FIG. 6B, the first module 662 includes the code functions 610 and 612, as well as the data groups 620 and 622. The second module 664 includes the code functions 614, 630 and 632. The second module 604 also includes the data groups 634, 636 and 638. The third module 666 includes the code functions 616, 618 and 642. The third module 666 also includes the data groups 626, 628, 646 and 648. The fourth module 668 includes code functions 640, 650 and 652, as well as the data groups 644, 654 and 656.

In the example of FIG. 6B, with respect to the first code module 662, the code function 610 directly references code function 612 (arrow 613). However, due to the regrouping, the first code module 662 now indirectly references code function 614 (dashed arrow 615′), code function 616 (dashed arrow 617′), and code function 618 (dashed arrow 619′).

With respect to the second code module 664, the code function 614 now directly references code function 630 (arrow 631′) and code function 632 (arrow 633′). The code function 630 still directly references data group 638 (arrow 637), and the code function 632 still directly references data group 638 (arrow 639).

With respect to the third code module 666, the code function 616 indirectly references code function 640 (dashed arrow 641), but now directly references code function 642 (arrow 643′). The code function 618 now directly references code function 642 (arrow 645′) and data group 648 (arrow 647′). The code function 642 still directly references data group 648 (arrow 649).

With respect to the fourth code module 668, the code function 640 now directly references code function 650 (arrow 651′). The code function 640 also directly references code function 652 (arrow 653′). The code function 650 still directly references code function 652 (arrow 655).

There are now twelve local calls (direct references) and only four external calls (indirect references) in the function call tree 660. By reducing the number of indirect references in half, the amount of unwanted overhead can be minimized.

The number of modules that can be loaded into the LS 302 is limited by the size of the LS 302 and by the size of the modules themselves. However, code analysis on how references are addressed provides a powerful tool, which may enable the loading or unloading of program modules in the LS 302 before they are needed. If it can be determined at a certain point in the program that a program module will be needed, the loading can be performed ahead of time to reduce the latency of loading modules on demand. Even if it is not completely certain that a given module will be used, in many cases it is more efficient to predictively load the module if it is very likely (e.g., 75% or more) to be used.

The references can be made strict, or on-demand checking may be permitted, depending upon the likeliness that the reference will actually be used. The insertion point in the program for such load routines can be determined statistically using a compiler or equivalent tool. The insertion point can also be determined statically before the module is created. The validity of the insertion point can be determined based upon runtime conditions. For example, a load routine may be utilized that judges whether the load should or should not be performed. Preferably, the amount of loading and unloading is minimized for a set of program modules loaded at run time. Runtime profiling analysis can provide up to date information to determine the locations of each module to be loaded. Due to typical stack management, arbitrary load locations should be chosen for modules that do not have further calls. For instance, in a conventional stack management process, stack frames are constructed by return pointers. When a function returns, the module containing the calling module must be located in the same location as when it was called. As long as a module is loaded to the same location when it returns, it is possible to load it to a different location each time the module is newly called. However, when returning from an external function call, the management routine loads the calling module to the original location.

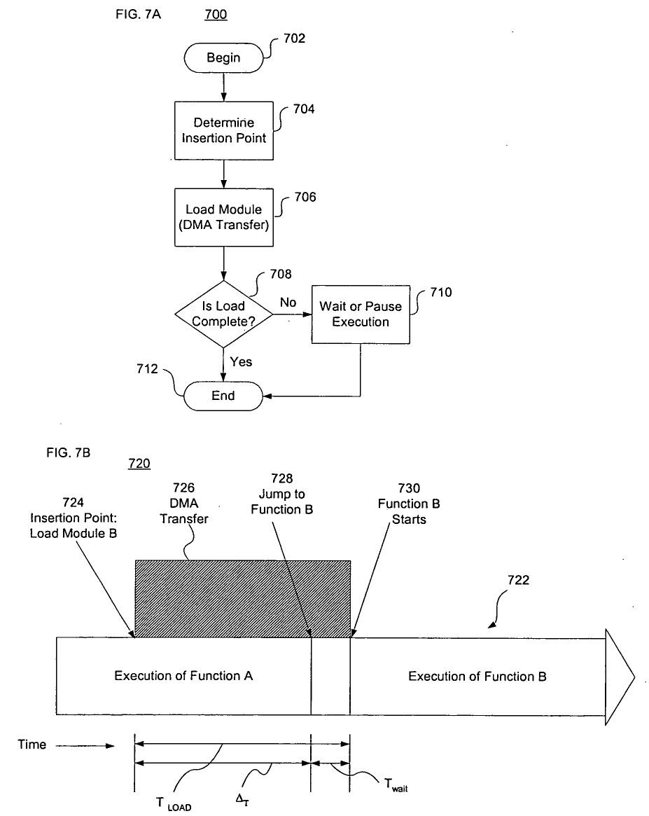

FIG. 7A is a flow diagram 700 illustrating a preloading process that initializes at step S702. In step S704, an insertion point is determined for the program module. As discussed above, the insertion point may be determined, for example, by a compiler or by profiling analysis. The path of execution branching can be represented by a tree structure. It is the position in the tree structure that determines whether the reference is going to be used or is likely to be used, for example based on a probability ranging from 0% to 100%, wherein a 100% probability means that the reference will definitely be used and a 0% probability means that the reference will not be used. Insertion points should be placed after a branch. Then, in step S706, the module or modules are loaded by, for example, a DMA transfer. Loading is preferably performed in a background process to minimize delays in code execution. Then, in step S708 it is determined whether loading is complete. If the process is not complete, then at step S710 code execution may be paused to permit full loading of the program modules. Once loading is complete, the process terminates at step S712.

FIG. 7B illustrates an example of program module preloading in accordance with FIG. 7A. As seen in the figure, code execution 722 is performed by a processor, for example, SPU 300. Initially, a first function A may be executed by the processor. Once an insertion point 724 is determined for a second function B as discussed above, a program module containing function B is loaded by, for example, a DMA transfer 726. The DMA transfer 726 takes some period of time, shown as T_{LOAD}. If the processor is ready to perform function B, for example due to a program jump 728 in function A, it is determined whether the load of program module B is complete as in step S708. As seen in FIG. 7B, the transfer 726 is not complete by the time the jump 728 occurs. Therefore, a wait period T_{WAIT} occurs until the transfer 726 is complete. The processor may, for example, perform one or more “no operations” (“NOPs”) during T_{wait}. Once T_{wait} is finished, the processor begins processing function B at point 730. Thus, it can be seen that, taking into account the wait period T_{wait} (if any), preloading of the module saves a time Δ_{T}.

A key benefit of program module optimization in accordance with aspects of the present invention is the minimization of the time spent waiting for the loading and unloading of modules. One factor that comes into play is the latency and the bandwidth of module transfers. The time spent during the actual transfer is directly related to the following factors: (a) the number of times a reference is made; (b) the latency for a transfer setup; (c) the transfer size; and (d) the transfer bandwidth. Another factor is the size of the available memory space.

While static analysis may be used as part of the code organization process, it generally is limited to providing relationships between the functions and does not provide information on how many times calls are made to a given function in a set period of time. Preferably, a reference to such static data is used as a factor in regrouping. Additional analysis of the code may also be used to provide some level of information on the frequency and number of times function calls are made within a function. In one embodiment, optimization may be limited to the information that can be obtained using only a static analysis.

Another element that can be included in the optimization algorithm is the size and expected layout of the modules. For example, if a caller module has to be unloaded to load the callee module, the unloading would add more latency to complete the function call.

In designing optimization algorithms, one or more factors (e.g., weighting factors) are preferably included, which are used to quantify the optimization. In one factor, the functional references are preferably weighted with the frequency of calls, the number of times the module is called, and the size of the module. For instance, the number of times a module may be called can be multiplied by the size of the module. In a static analysis mode, function calls farther down the call tree could be given more weighting to indicate that the call would be made more frequently.

In another factor, if a call remains within a module (a local reference), the weighting can be reduced or given a weight of zero. In a further factor, different weights can be set to call from a function with analysis of the code structure. For example, a call made only one time is desirably weighted lower than a call made numerous times as part of a loop. Furthermore, if the number of loop iterations can be determined, that number could be used as the weighting factor for the loop call. In yet another factor, a static data reference used only by a single function should be considered as attached to that function. In another factor, if static data is shared between different functions, it may be desirable to include those functions in a single module.

In a further factor, if an entire program is small enough, the program should be placed into a single module. Otherwise, the program should be split into multiple modules. In another factor, if the program module is split into multiple modules, it is preferable to organize the modules so that both caller and callee modules fit into the memory together. The last two factors relating to splitting a program into a module should be evaluated in view of the other factors in order to achieve a desirable optimization algorithm. The figures discussed above illustrate various reorganizations in accordance with one or more selected factors.

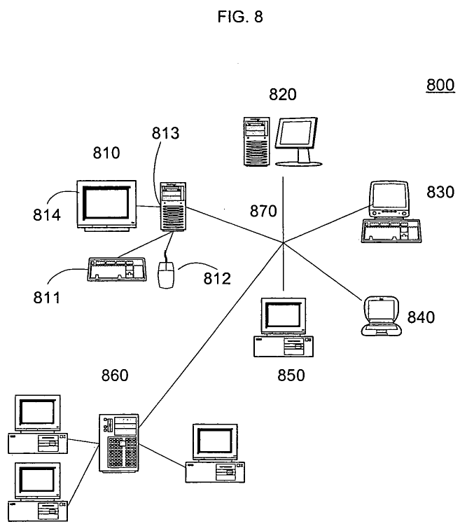

FIG. 8 is a schematic diagram of a computer network depicting various computing devices that can be used alone or in a networked configuration in accordance with the present invention. The computing devices may comprise computer-type devices employing various types of user inputs, displays, memories and processors such as found in typical PCs, laptops, servers, gaming consoles, PDAs, etc. For example, FIG. 8 illustrates a computer network 800 that has a plurality of computer processing systems 810, 820, 830, 840, 850 and 860, connected via a communications network 870 such as a LAN, WAN, the Internet, etc. and which can be wired, wireless, a combination, etc.

Each computer processing system can include, for example, one or more computing devices having user inputs such as a keyboard 811 and mouse 812 (and various other types of known input devices such as pen-inputs, joysticks, buttons, touch screens, etc.), a display interface 813 (such as connector, port, card, etc.) for connection to a display 814, which could include, for instance, a CRT, LCD, or plasma screen monitor, TV, projector, etc. Each computer also preferably includes the normal processing components found in such devices such as one or more memories and one or more processors located within the computer processing system. The memories and processors within such computing device are adapted to perform, for instance, processing of program modules using programming references in accordance with the various aspects of the present invention as described herein. The memories can include local and external memories for storing code functions and data groups in accordance with the present invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of managing operations in a processing apparatus having a local memory, comprising:
determining if a program module is loaded in the local memory, the programming module being associated with a programming reference;
loading the program module into the local memory if the program module is not loaded in the local memory; and
obtaining information from the program module based upon the programming reference.

2. The method of claim 1, wherein the information obtained from the program module comprises at least one of data and code.

3. The method of claim 1, wherein the program module comprises an object module loaded in the local memory from a main memory.

4. The method of claim 1, wherein the programming reference comprises a direct reference within the program module.

5. The method of claim 1, wherein the programming reference comprises an indirect reference to a second program module.

6. The method of claim 1, wherein the program module is a first program module, the method further comprising:
storing the first program module and a second program module in a main memory;
wherein the loading step includes loading the first program module into the local memory from the main memory.

7. The method of claim 6, wherein the programming reference comprises a direct reference within the first program module.

8. The method of claim 6, wherein the programming reference comprises an indirect reference to the second program module.

9. The method of claim 8, wherein the information is obtained from the second program module, the method further comprising:
determining if the second program module is loaded in the local memory;
loading the second program module into the local memory if the second program module is not loaded in the local memory; and
providing the information to the first program module.

10. A method of managing operations in a processing apparatus having a local memory, the method comprising:
obtaining a first program module from a main memory;
obtaining a second program module from the main memory;
determining if a programming reference used by the first program module comprises an indirect reference to the second program module; and
forming a new program module if the programming reference comprises the indirect reference, the new program module comprising at least a portion of the first program module so that the programming reference becomes a direct reference between portions of the new program module.

11. The method of claim 10, further comprising loading the new program module into the local memory.

12. The method of claim 10, wherein the first and second program modules are loaded in the local memory before forming the new program module.

13. The method of claim 10, wherein the first program module comprises a first code function, the second program module comprises a second code function, and the new program module is formed to include at least one of the first and second code functions.

14. The method of claim 13, wherein the first program module further comprises a data group, and the new program module is formed to further include the data group.

15. The method of claim 10, wherein the programming reference is an indirect reference to the second program module, the method further comprising:
determining a new programming reference for use by the new program module based on the programming reference used by the first program module;
wherein the new program module is formed to comprise at least the portion of the first program module and at least a portion of the second program module so that the new programming reference is a direct reference within the new program module.

16. A method of processing operations in a processing apparatus having a local memory, the method comprising:
executing a first program module loaded in the local memory;
determining an insertion point for a second program module;
loading the second program module in the local memory during execution of the first program module;
determining an anticipated execution time to begin execution of the second program module;
determining whether loading of the second program module is complete; and
executing the second program module after execution of the first program module is terminated.

17. The method of claim 16, further comprising delaying execution of the second program module if loading is not complete.

18. The method of claim 17, wherein delaying execution comprises performing one or more NOPs until loading is complete.

19. The method of claim 16, wherein the insertion point is determined statistically.

20. The method of claim 16, wherein the validity of the insertion point is determined based on runtime conditions.

21. A processing system, comprising:
a local memory capable of storing a program module; and
a processor connected to the local memory, the processor including logic to perform a management function comprising associating a programming reference with the program module, determining if the program module is currently loaded in the local memory, loading the program module into the local memory if the program module is not currently loaded in the local memory, and obtaining information from the program module based upon the programming reference.

22. The processing system of claim 21, wherein the local memory is integrated with the processor.

23. A processing system, comprising:
a local memory capable of storing program modules; and
a processor connected to the local memory, the processor including logic to perform a management function comprising storing first and second ones of the program modules in a main memory, loading a selected one the first and second program modules into the local memory from the main memory, associating a programming reference with the selected program module, and obtaining information based upon the programming reference.

24. The system of claim 23, wherein the main memory comprises an on-chip memory.

25. The system of claim 24, wherein the main memory is integrated with the processor.

26. A processing system, comprising:
a local memory capable of storing program modules; and
a processor connected to the local memory, the processor including logic to perform a management function comprising obtaining a first program module from a main memory, obtaining a second program module from the main memory, determining a first programming reference for use by the first program module, forming a new program module comprising at least a portion of the first program module so that the first programming reference becomes a direct reference within the new program module, and loading the new program module into the local memory.

27. A processing system, comprising:
a local memory capable of storing the program modules; and
a processor connected to the local memory, the processor including logic to perform a management function comprising determining an insertion point for a first program module, loading the first program module in the local memory during execution of a second program module by the processor, and executing the first program module after execution of the second program module is terminated and loading is complete.

28. A storage medium storing a program for use by a processor, the program causing the processor to:
identify a program module associated with a programming reference;
determine if the program module is currently loaded in a local memory associated with the processor;
load the program module into the local memory if the program module is not currently loaded in the local memory; and
obtain information from the program module based upon the programming reference.

29. A storage medium storing a program for use by a processor, the program causing the processor to:
store first and second program modules in a main memory;
load the first program module into a local memory associated with the processor from the main memory, the first program module being associated with a programming reference; and
obtain information based upon the programming reference.

30. A storage medium storing a program for use by a processor, the program causing the processor to:
obtain a first program module from a main memory;
obtain a second program module from the main memory;
determine if a programming reference used by the first program module comprises an indirect reference to the second program module; and
form a new program module if the programming reference comprises the indirect reference, the new program module comprising at least a portion of the first program module so that the programming reference becomes a direct reference between portions of the new program module.

31. A storage medium storing a program for use by a processor, the program causing the processor to:
execute a first program module loaded in a local memory associated with the processor;
determine an insertion point for a second program module;
load the second program module in the local memory during execution of the first program module;
determine an anticipated execution time to begin execution of the second program module;
determine whether loading of the second program module is complete; and
execute the second program module after execution of the first program module is terminated.

32. A processing system, comprising:
a processing element including a bus, a processing unit and at least one sub-processing unit connected to the processing unit by the bus;
wherein at least one of the processing unit and the at least one sub-processing units are operable to determine whether a programming reference belongs to a first program module, to load the first program module into a local memory, and to obtain information from the first program module based upon the programming reference.

33. A computer processing system, comprising:
a user input device;
a display interface for attachment of a display device;
a local memory capable of storing program modules; and
a processor connected to the local memory, the processor comprising one or more processing elements, at least one of the processor elements including logic to perform a management function comprising determining whether a programming reference belongs to a first program module, loading the first program module into the local memory, and obtaining information from the first program module based upon the programming reference.

34. A computer network, comprising:
a plurality of computer processing systems connected to one another via a communications network, each of the computer processing systems comprising
a user input device;
a display interface for attachment of a display device;
a local memory capable of storing program modules; and
a processor connected to the local memory, the processor comprising one or more processing elements, at least one of the processor elements including logic to perform a management function comprising determining whether a programming reference belongs to a first program module, loading the first program module into the local memory, and obtaining information from the first program module based upon the programming reference.

35. The computer network of claim 34, wherein at least one of the computer processing systems comprises a gaming unit capable of processing multimedia gaming applications.
